(19) United States
(12) Patent Application Publication
(10) Pub. No.: US 2003/0016239 A1
(43) Pub. Date: Jan. 23, 2003

(54) Method and apparatus for providing a graphical depiction of events

(76) Inventor: Teresa Michelle Christopher, Denver, CO (US)

Correspondence Address: SHERIDAN ROSS PC, 1560 BROADWAY, SUITE 1200, DENVER, CO, 80202

(21) Appl. No.: 09/910,310

(22) Filed: Jul. 19, 2001

(51) Int. Cl. G09G 5/00

(52) U.S. Cl. 345/712; 345/747

(57) ABSTRACT

A method and apparatus for providing a graphical depiction of events are provided. According to the present invention, a time line or path along which a plurality of images or text may be arranged is provided. Images are selected by selecting a theme, and then an image grouped under the selected themes. Subthemes and sub-subthemes may additionally be provided to further subdivide images and facilitate the location and selection of the desired image. User entered text may be associated with a selected image. The present invention allows graphical depictions of events, and in particular depictions of a chronology of events, to be constructed.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates to the graphical depiction of events. In particular, the present invention relates to the depiction of life events using textual description and graphical images.

### BACKGROUND OF THE INVENTION

Increasingly, consumers desire personalized products. For example, greeting card companies and others allow consumers to create greeting cards containing user selected text and graphics. In addition, scrapbooks in which photographs, memorabilia and annotations may be placed have long been available. Additionally, computer programs allow users to associate user defined text with user selected graphics. However, available automated methods for associating text with graphics, such as greeting card programs and word processing programs with graphical capabilities, do not lend themselves to graphically depicting a chronology of events.

A time line is a useful method for displaying a chronology of events. Although time lines combining text and graphical images have been used, for example in connection with descriptions of historical events, such time lines have been laborious to produce. In particular, such time lines have required their creators to select and format any textual description, obtain and select appropriate graphical images, if any, and manually arrange the text and images in an appropriate order along the time line. Furthermore, time lines are typically constructed along a straight, unadorned line, and are therefore visually uninteresting.

It would be advantageous to provide a method and an apparatus that enabled users to graphically depict a chronology of events using text and associated graphics. In addition, it would be advantageous to provide a method and an apparatus for graphically depicting events that formatted text entered by a user and associated graphics selected by the user for display along a path. Furthermore, it would be advantageous to provide such a method and an apparatus that could be provided on a per use basis over a computer network, such as the Internet. It would also be advantageous to provide a method and an apparatus that provided a user with images available for association with text entered by the user that were sorted according to predetermined themes. Furthermore, it would be advantageous to provide a method and an apparatus for graphically depicting events that allowed users to produce hard copies or electronic copies of the graphical depiction created by the user, and that could be provided at reasonable cost, without requiring input from any person other than the user.

### SUMMARY OF THE INVENTION

In accordance with the present invention, a method and an apparatus for graphically depicting events are provided. The present invention generally allows a user to select an image related to an event and place the selected image on a time line according to a predetermined format. The user may also be allowed to enter text to associate with each selected image. The text may describe events that form part of a chronology of events. The text and associated graphics are placed on a time line according to a predetermined format. The graphical depiction of events, or story map, thus created may be output by the user for display or later reference.

According to one embodiment of the present invention, a method and an apparatus are provided in which a user may insert a title for the graphical depiction of events. The user may also enter a textual description of an event. The user may then select from a set of images an image for association with the entered text. The user may establish a plurality of textual description and image pairs. The particular format, including the shape of the time line, the beginning and end points, and the locations of positions provided for placing images and text may be selected by the user. The text and image pairs are arranged along a time line according to the selected format. In this way, the events within a chronology of events may be displayed in chronological order along a line.

According to an embodiment of the present invention, the images available to a user for association with textual description are in accordance with a selected theme. For example, the user may select from achievements, future, growing up, interests, hobbies, marriage, anniversary, sports, athletics, babies, generic, high school, college graduation, retirement, work, career and life change themes. Accordingly, the user is presented with only those images that are in accordance with the user selected theme. According to another embodiment of the present invention, the user may choose to enter text for placement along the time line, without selecting images for association with the entered text.

According to still another embodiment of the present invention, a user may edit the entered text and selected images until a final version of the map graphically depicting the events is created. Furthermore, the user may be allowed to create a full color, high resolution hard copy output of the map after a final version has been created.

In accordance with still another embodiment of the present invention, maps depicting converging events may be created. According to yet another embodiment of the present invention, depictions of events contained on a first map may be formatted to link with depictions of events contained on a second map.

In accordance with an embodiment of the present invention, the time line about which the images and/or text graphically depicting events is arranged is a path. In accordance with a further embodiment of the present invention, the path may be depicted as a road, railroad tracks, a river, a sidewalk, or a footpath.

According to still another embodiment of the present invention, the user may choose a different background or path. When a new background or path is chosen, text and images associated with the originally selected background or path are associated with the newly selected background or path automatically.

Based on the foregoing summary, a number of salient features of the present invention are readily discerned. A method and an apparatus for graphically depicting a series of events are provided. The method and apparatus of the present invention enable users to enter text that may be selectively associated with graphical images. The graphical images may be chosen by users from sets of images arranged according to predetermined themes. The method and apparatus of the present invention formats the user entered text and associated image, and places the text and associated image, if any, along a path. The path may be used to create a time line. The present invention facilitates the depiction of a chronology of events, such as events related to a major life event. In addition, the present invention provides a framework for arranging a depiction of events, and allows the depiction of events to be illustrated as selected by the user.

Additional advantages of the present invention will become readily apparent from the following discussion, particularly when taken together with the accompanying drawings.

### BRIEF DESCRIPTION OF THE DRAWINGS

FIG. 1 is a block diagram depicting the major components of a system in accordance with an embodiment of the present invention;

FIG. 2 is a block diagram depicting the major divisions of a database used in connection with an embodiment of the present invention;

FIG. 3 is a depiction of a background template in accordance with an embodiment of the present invention;

FIG. 4 is a functional flow diagram depicting the operation of an embodiment of the present invention;

FIG. 5 is an example story map created using a story map builder in accordance with an embodiment of the present invention;

FIG. 6 is a screen shot of a home page in accordance with an embodiment of the present invention;

FIG. 7 is a screen shot of a story map builder home page in accordance with an embodiment of the present invention;

FIG. 8 is a screen shot of a log-in web page in accordance with an embodiment of the present invention;

FIG. 9 is a screen shot of a story map selection web page in accordance with an embodiment of the present invention;

FIG. 10 is a screen shot of a new map name and title web page in accordance with an embodiment of the present invention;

FIG. 11 is a screen shot of a web page to select a previously created story map in accordance with an embodiment of the present invention;

FIG. 12 is a screen shot of a background selection web page in accordance with an embodiment of the present invention;

FIG. 13 is a screen shot of a selected background web page in accordance with an embodiment of the present invention;

FIG. 14 is a screen shot of an image theme selection web page in accordance with an embodiment of the present invention;

FIG. 15 is a screen shot of a subtheme select ion web page in accordance with an embodiment of the present invention;

FIG. 16 is a screen shot of an image selection web page in accordance with an embodiment of the present invention;

FIG. 17 is a screen shot of a web page showing an example of a background and a first selected image in accordance with an embodiment of the present invention;

FIG. 18 is a screen shot of a text entry web page in accordance with an embodiment of the present invention; and

FIG. 19 is a screen shot of a web page showing an example of a background and a first selected image and first selected text in accordance with an embodiment of the present invention.

### DETAILED DESCRIPTION

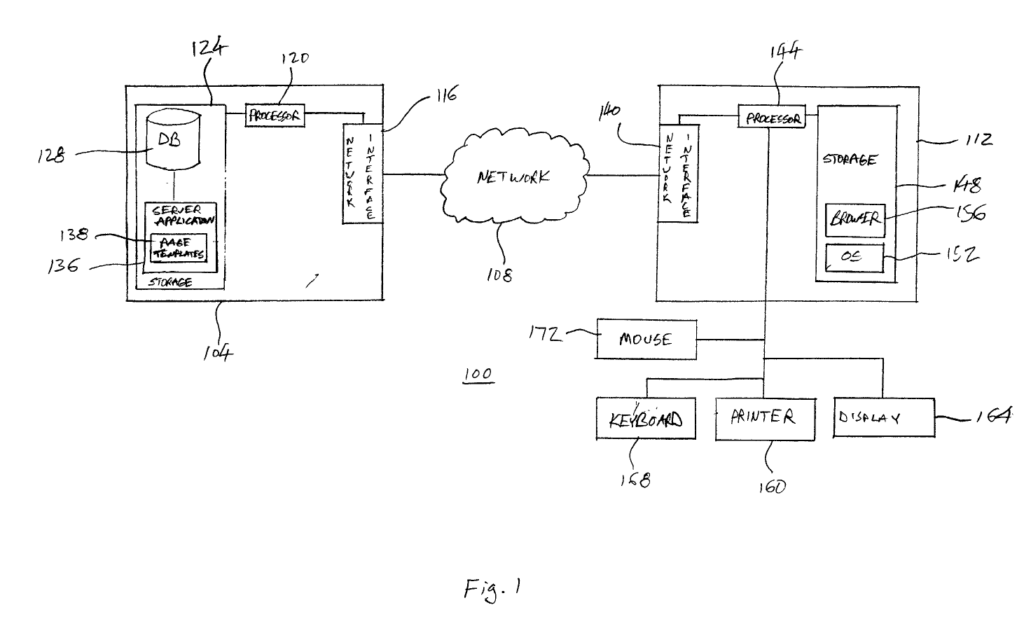

FIG. 1 illustrates a system 100 in accordance with an embodiment of the present invention. The system 100 generally includes a server computer 104, a network 108, and a client computer 112.

The server 104 generally includes a network interface 116 interconnected to a processor 120, which is in turn interconnected to storage 124. The storage 124 may include a database 128 and a stored server application program 136. The server application program 136 may include page templates 138 for generating web pages that are provided to the network 108 for display on the client computer 112.

The network 108 may be any computer network or communication network capable of being used to establish communications between two computers. In addition, the network 108 may be formed from a number of such computer networks or communication systems. According to one embodiment of the present invention, the network 108 includes the Internet.

The client computer 112 may include a network interface 140 interconnected to a processor 144 that is in turn interconnected to storage 148. According to one embodiment of the present invention, the client computer 112 is any general or personal type computer. In particular, the client computer 112 may be any computer capable of running a graphical web browser that enables a Flash plug-in. According to a further embodiment of the present invention, the client computer 112 is a PC computer running on a MICROSOFT WINDOWS operating system, or an APPLE computer running an APPLE operating system. The storage 148 may contain operating system software 152 and communications software necessary for the client computer 112 to communicate with a server 104 over a network 108, such as an Internet browser program 156. A printer 160, and user interface devices, such as a user display 164, a keyboard 168 and a mouse 172 may be operatively connected to the client computer 112.

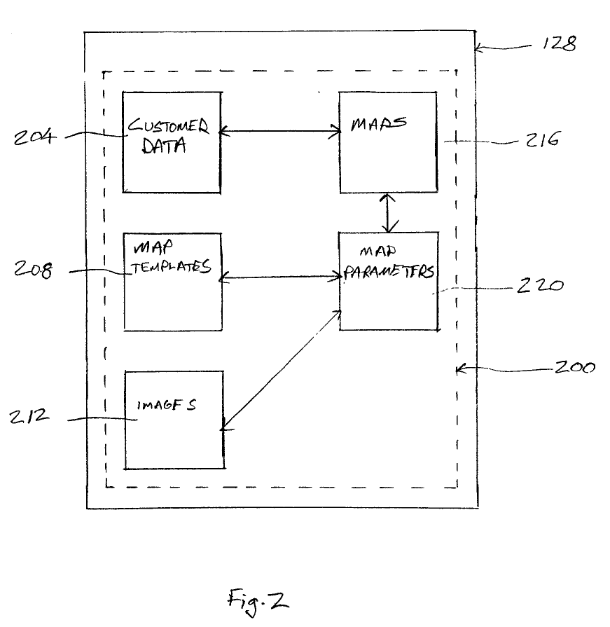

With reference now to FIG. 2, the major divisions of a database 128 in accordance with an embodiment of the present invention are illustrated. In particular, the database 128 includes a story map builder utility 200. The story map builder utility may be subdivided into a customer data table 204, a templates table 208, an images table 212, a maps table 216, and a map parameters table 220. Additional tables may be provided as deemed necessary to provide a logical and convenient division of information and to provide for the efficient administration of the system 100. For example, a table can be created for collecting information regarding how often particular images are selected by users. Interconnections or dependencies between the divisions of the database 128 are also illustrated in FIG. 2.

The customer data table 204 generally includes a record for each customer or user of a service implementing an embodiment of the method or apparatus of the present invention. Within the customer data records are various fields, such as a name, e-mail and password field. According to one embodiment of the present invention, all or none of the fields provided within a record in the customer data database need to be completed. For example, a customer or user may construct a graphical depiction of events, or story map, without providing any identifying information. Alternatively, an entry in each or a selected subset of the fields may be required before a user is permitted to create a story map or perform certain functions with respect to a story map. For example, in accordance with one embodiment of the present invention, a user is required to provide an e-mail address as an identifier and a password prior to saving a story map. In addition to the fields for containing user data, each customer data record may contain references to one or more story maps created by the user.

The maps table 216 may include records containing general information regarding story maps created in connection with associated customer data records. The story map records may include the name assigned to the story map by the user, such as a file name, the title of the story map entered by the user, the selected background, whether the story map has been purchased, and the date that the story map was created. The records in the map table may further include information associating each story map with a record in the map parameters table 220.

Each story map parameter record stored as part of the map parameters table 220 may include fields for storing text values that are associated with each text position provided by the map background specified in the maps table 216 for the associated story map. Accordingly, text fields are provided for as many text positions as are provided by the selected background, as will be described in greater detail below. Records in the map parameters table 220 may also include fields containing information regarding images selected for placement at predefined positions on a selected background. Accordingly, at least as many image fields may be provided by a record in the map parameters table 220 as there are image positions provided on a selected background.

Each record in the map parameters table 220 is associated a map template stored in the map templates table 208. In general, each map template includes graphical and formatting information related to the background selected by the user, which selection is reflected by the value stored in the background field of the related record in the maps table 216.

As noted above, a record in the map parameters table 220 may contain fields that refer to one or more images stored in the images table 212. In particular, images stored as part of the images table may be associated with each milepost or available position for images on the selected background, as specified in the image fields of the record in the map parameters table 220.

As can be appreciated by one of skill in the art, a story map builder utility 200 in accordance with the present invention may be constructed using available web site development, report creation and database programs. In an embodiment of the present invention operated as an on-line service, the story map builder utility 200 for creating a graphical depiction of events may be created using an available web site development program, such as the WEBOBJECTS development tool. WEBOBJECTS may be used to determine the look and feel of the story map builder utility 200 by determining the HTML code that is dynamically generated in response to user selections. In connection with the story map builder utility 200, a report generating tool such as REPORTMILL may be used to generate the output (e.g. HTML, QUICK TIME, .pdf, or FLASH files) provided to the client computer 112. In addition, a database program, such as OPEN BASE, may be used to create and maintain the various tables.

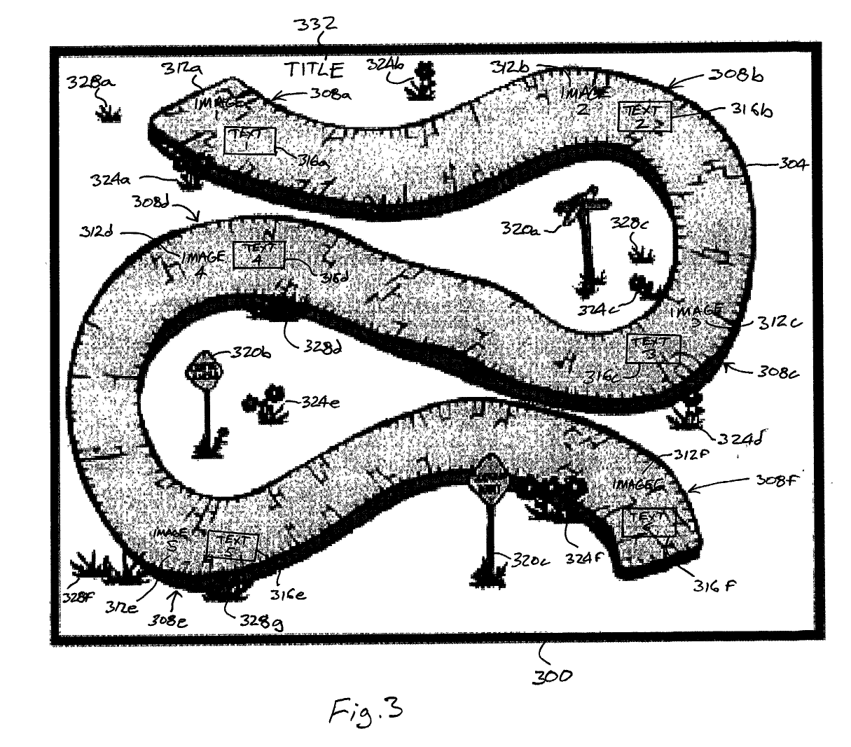

With reference now to FIG. 3, a representative background 300 is illustrated. Depicted on the background 300 is a path 304. The path 304 is, in the illustrated embodiment, shown as a brick path or road. However, the path 304 may be depicted as any type of continuous line. Preferably, the path 304 suggests movement along a continuum. Therefore, structures such as roads, railroad tracks, rivers, sidewalks, and foot paths are particularly well suited for depicting a path 304.

Along the path, various mileposts 308a, 308b, 308c, 308d, 308e and 308f are provided. Each milepost 308 may include an image area 312, and a text area 316. The image areas 312 are areas along the path 304 in which a selected image may be positioned, as will be described in greater detail below. The text areas 316 are areas in which text specified by a user may be positioned. In the embodiment illustrated in FIG. 3, the background template 300 additionally includes graphical elements, such as sign posts 320, flowers 324, and plants 328 to enhance the depiction of the path 304. According to an embodiment of the present invention, the user may select the particular graphical elements 320-328 that are displayed and the location of those elements. According to a further embodiment of the present invention, the user may choose to have no graphical elements 320-328 on the background 300. Of course, such graphical elements 320, 324 and 328 are not required. The background template 300 may also include a title area 332 in which a title specified by the user may be placed.

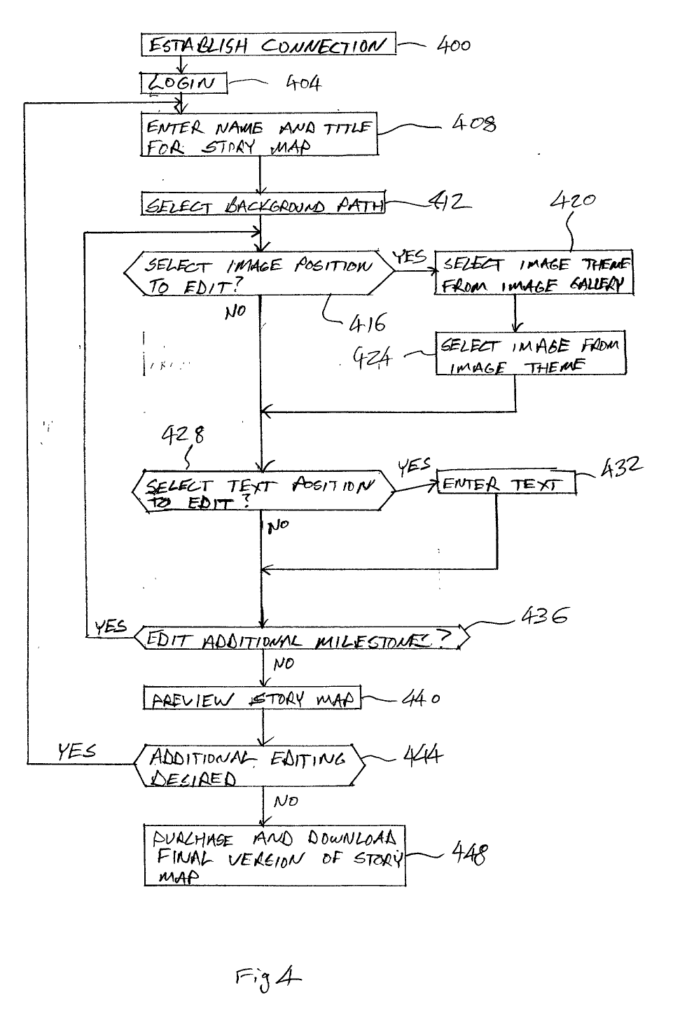

With reference now to FIG. 4, the operation of an embodiment of the present invention in connection with building a story map is illustrated. Initially, at step 400, a user establishes a connection to the server computer 104. For example, the user may direct a browser 156 associated with the client computer 112 to the universal resource locator (URL) of the server 104 when the network 108 includes the Internet. In response to the establishment of a connection between the server 104 and the client computer 112, the server application program 136, and in particular the story map builder utility 200, may present a web page that allows the user to log in by providing identifying information. As can be appreciated by one of skill in the art, the web page may be constructed using hyper text markup language (HTML). In addition, dynamic aspects of the web page that may be provided can be constructed using FLASH movies to provide animation. At step 404, the user logs in. The user log-in may include providing various information identifying the user. For example, according to one embodiment of the present invention, the user must supply at least an e-mail address in order to save a story map that the user has created. According to an embodiment of the present invention, the user is not required to log-in in order to begin building a story map. If the user has previously established an account in connection with the system 100, the user may log in by providing an identifier, such as an e-mail address, and a password.

At step 408, the user may enter a file name and a title for the story map. In general, the file name is used to identify the particular story map that the user is creating, while the title appears on the face of the story map (e.g., title 332 in FIG. 3). The user may then select a desired background (e.g., background 300) (step 412). As illustrated in FIG. 3, a background 300 provides a plurality of mileposts 308 with respect to which images and/or text may be positioned. Particular backgrounds 300 may differ from one another in the number of mileposts 308 available, the graphical depiction of the path 304, and the theme or presence of any graphical elements (e.g., graphical elements 320, 324 and 328). In addition, the progression of the path 304 across or within the background 300 may vary for different backgrounds. For example, the background 300 depicted in FIG. 3 features a path 304 that progresses from the upper left of the background to the lower right. Another background that may be selected might provide a path 304 that progresses from the upper to the lower left. As can be appreciated, the particular configuration of a path's 304 progression across a background 300 is limitless. According to still a further embodiment, a path 304 may include branches to facilitate the depiction of a convergence of events. Backgrounds 300 that allow print outs of one background to be joined to another background to create a larger overall story map may also be provided. According to a further embodiment of the present invention, a user may change the selected background 300 even after creation of a story map has begun or has otherwise been completed.

After the user has selected a background 300, the user may begin to select and edit images and text for association with each milepost 308. Thus, at step 416, a determination is made as to whether the user has selected an image position 312 to edit. If yes, the user is presented with a listing or menu of image themes. Accordingly, the user then selects one of the image themes from an image gallery (step 420). The user is then presented with a display of the images included in the selected image theme, from which one of the images from those displayed may be selected (step 424).

In accordance with one embodiment of the present invention, the server application 136 dynamically constructs the web pages used to present information to the user. For example, in response to the selection of an image theme by the user, the server application 136 may make reference to a report template used to present the appropriate information to the user. In general, the report template includes a listing of the images included in the image theme. The listing of images may comprise a listing of image addresses, files, or other identifiers. The web page presented to the user is dynamically generated in that certain elements, such as the particular images displayed, are retrieved from the collection of stored images 212 according to the listing. As can be appreciated by one of skill in the art, this arrangement allows different image themes to share individual images, while minimizing the size of the web pages used to display images included in the image themes.

After an image has been selected, or if an image position 312 has not been selected to edit, a determination is made as to whether a text position 316 has been selected for editing (step 428). If a text position 316 has been selected for editing, the user is provided with a text box in which the desired text may be entered (step 432). The number of characters that can be entered in the text box may be limited in order to ensure that the text will fit in the selected text position 316 along the path 304. In accordance with one embodiment of the present invention, the number of characters that may be entered can be varied according to the selected font type and/or size. According to a further embodiment of the present invention, a user may specify up to 150 characters for each text position 316.

After any desired text has been entered, or if a text position 316 has not been selected for editing, a determination is made as to whether the user desires to edit additional mileposts 308 (step 436). If yes, the system returns to step 416, and the user may select additional image positions 312 and text positions 316 for editing. Although FIG. 4 depicts the selection of an image position 312 prior to a text position 316 for a milepost 308, such a relationship is not required. For example, in accordance with one embodiment of the present invention, a user may select any image position 312 or any text position 316 along a path 304 for editing simply by operating a pointing device (e.g. mouse 172) to select the desired position 312 or 316. Accordingly, a user may selectively edit any image position 312 and any text position 316 in any order the user desires.

If the user has completed editing of the background 300, the system proceeds to step 440, at which point the story map may be previewed. In accordance with one embodiment of the present invention, the user may, in addition to review of the story map on a display 164 associated with the client computer 112, print a hard copy of the story map (e.g., on printer 160). In accordance with one embodiment of the present invention, the user is limited to printing a black and white version of the story map if a final version has not been purchased. Previewing the story map allows the user to determine whether additional editing is desired before a final version of the story map is purchased.

Accordingly, at step 444, a determination is made as to whether the user wishes to continue editing the story map. If additional editing is desired, the user is allowed to make any such edits. Although in FIG. 4 the system is depicted as returning the user to step 408, at which a name and title 332 for the story map may be entered, a return to this step is not required. For example, the user may instead choose to edit a image position 312 or text position 316 without returning to blocks allowing the name and title 332 of the story map. Furthermore, a user may choose to edit an image position 312 or a text position 316 by directing a pointing device to the desired position 312 or 316 and selecting that position 312 or 316.

After the user has completed any additional editing, or if no additional editing is desired, the user may purchase and download a final version of the story map (step 448). In general, the final version of the story map is downloaded as a unitary graphical image. For example, the final version may be provided as a portable document format (.pdf) file. In addition, the final version of the story map may be provided to the user in full color and at a higher resolution than is provided in connection with preview versions or with versions intended for display on a display 164 associated with the client computer 112, for example while the story map is being constructed. In accordance with an embodiment of the present invention, the final version of the story map may be downloaded to a client computer 112 using a dial-up number as the network interface 140 in less than 3 minutes.

In accordance with still another embodiment of the present invention, the user may select to download a large format (e.g., poster size) version of the story map, rather than a standard letter size version. In accordance with a further embodiment of the present invention, the large format version is provided at an increased resolution as compared to the standard letter size version. The larger and/or higher quality final version may be provided at additional cost to the user, or may simply be provided to a user in response to a request for the higher quality version. For example, where the user has a printer capable of producing a hard copy of the story map at the enhanced resolution of the higher quality version, the only additional cost to the user may be an increased download time.

As an additional output option, the user may choose to send an electronic copy of the final version of a story map to someone other than the user. For example, if the story map has been created by the user as a gift, the final version of the story map may be sent directly from the server 104 to the recipient's e-mail address. According to a further embodiment of the present invention, multiple copies of the final story map may be sent to recipients by e-mail.

A final version of a story map may also be provided to a commercial printer capable of producing large format hard copy. Delivery of the story map in electronic (e.g. portable document format or .pdf) form may be completed by e-mailing the story map file directly from the server 104 to the commercial printer. Alternatively, the user may e-mail the file from the client computer 112. As a further alternative, the commercial printer may be provided with the file on removable media, such as a floppy disk, CD-R disk, or CD-RW disk.

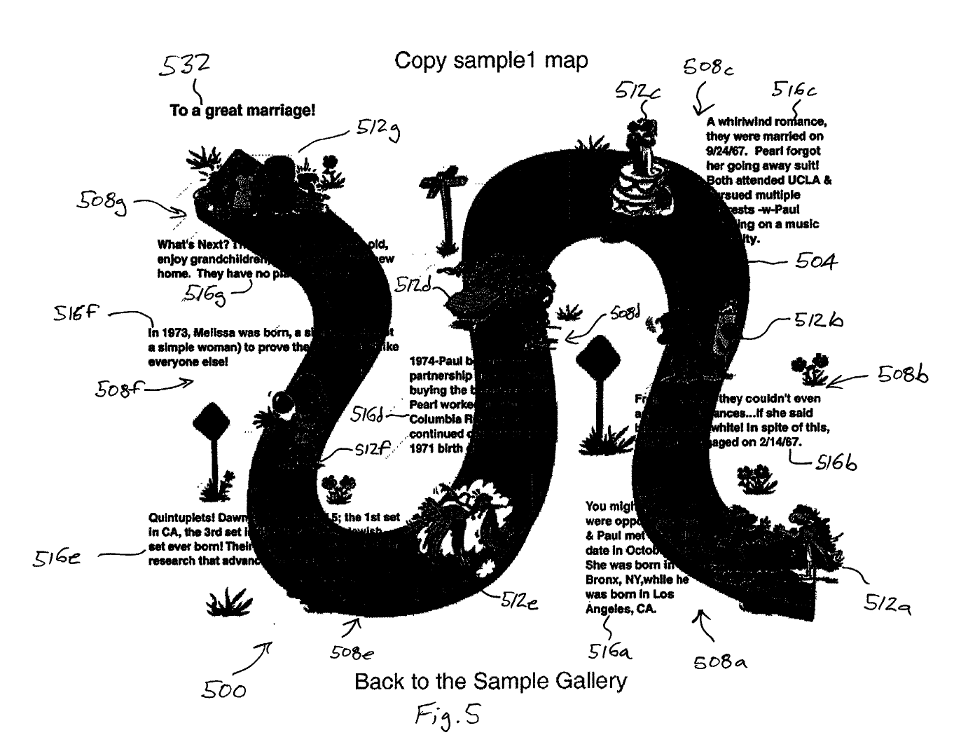

FIG. 5 is an example of a story map 500 created using the story map builder of the present invention. In FIG. 5, the path 504 can be seen to be a brick or stone walkway. Along the path 504, seven mileposts 508a-g are shown. Each milepost 508a-g includes an associated image 512 and text 516.

As can be appreciated from a review of the sample story map 500, the story of a couple's life together, from the time they met until the present, is presented. Thus, at the first milepost, the text 516a describes the couple meeting on a blind date. The image 512a associated with the first milepost 508a depicts a blindfolded couple running towards one another. Accordingly, it can be appreciated that the creator of this story map 500 chose a first image 512a that complemented the entered text 516a. The story then proceeds in chronological order along the path, and through mileposts 2-7 (508b-508g). In the following description, the steps that can be taken by a user to create the example story map shown in FIG. 5 utilizing an embodiment of the present invention are described.

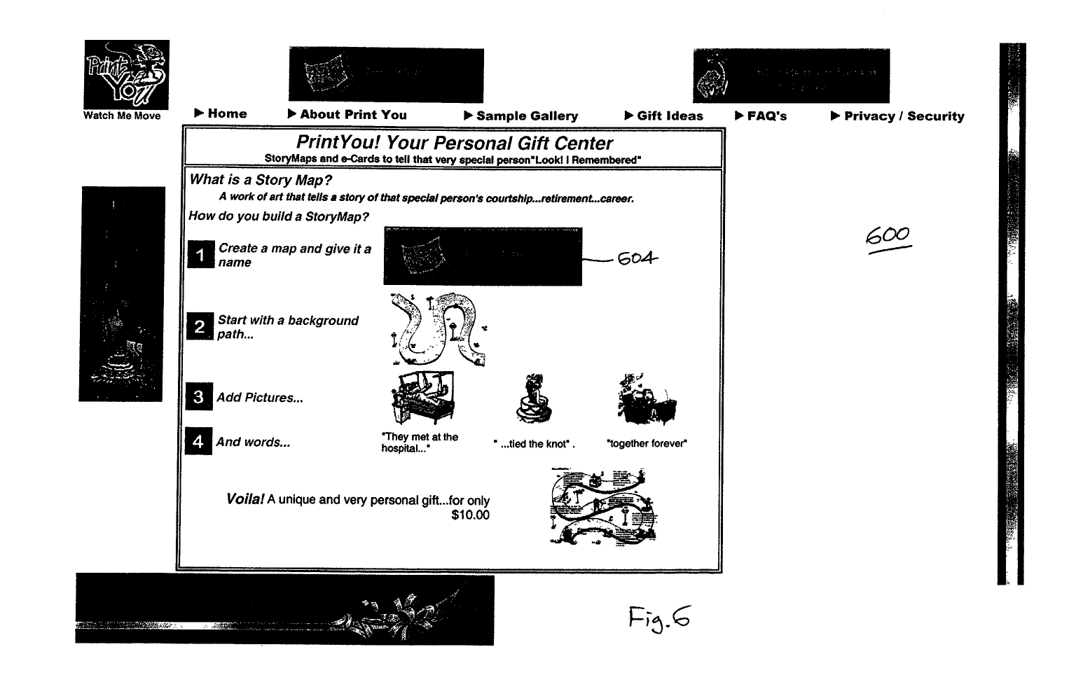

With reference now to FIG. 6, a screen shot of a home page 600 that may be presented to a user after a connection is established with the server 104 is shown. Included in FIG. 6 is a story map button 604, allowing the user to choose to create a story map.

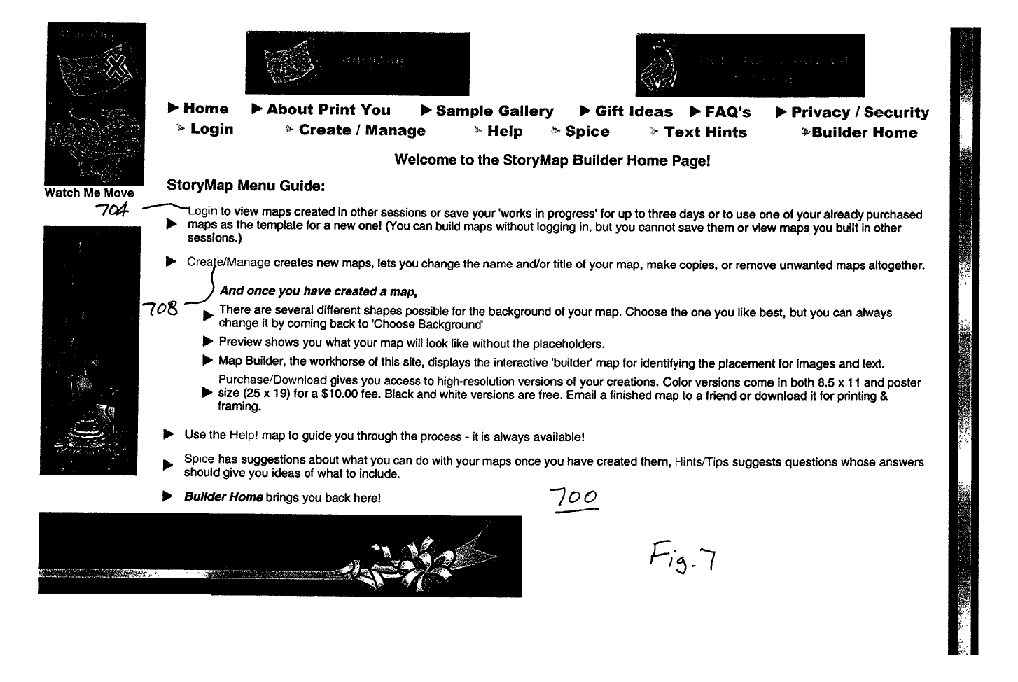

FIG. 7 illustrates a screen shot of a story map home web page 700 that may be presented to a user following selection of the story map button 604 of FIG. 6. The story map home page 700 includes a first link 704 that can be selected to allow a user to log in. A second link 708 allowing a user to create a new map or manage previously created maps may also be provided. The user may choose to create a map by selecting the first link 704 prior to logging-in. However, the user will generally be required to log in before a copy of the story map is saved, before a preview version may be downloaded, or before a final version of a story map (e.g., story map 500) may be purchased and downloaded. In addition, story maps created while logged-in to the system are available for editing during later sessions if the same log in information (e.g., e-mail address and password) are used in the later session.

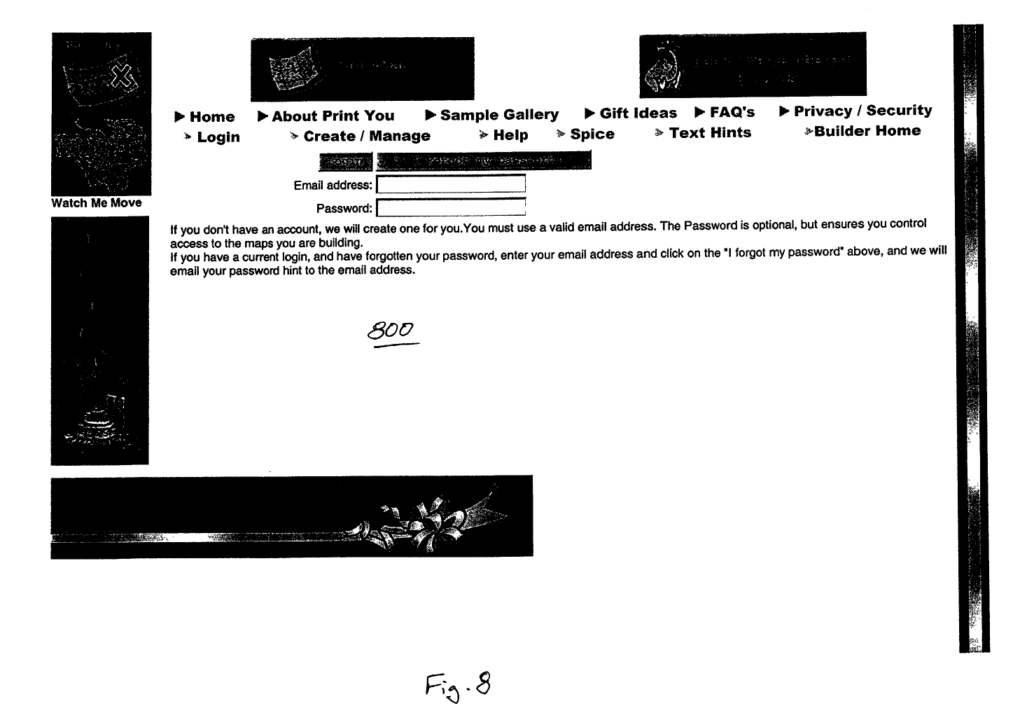

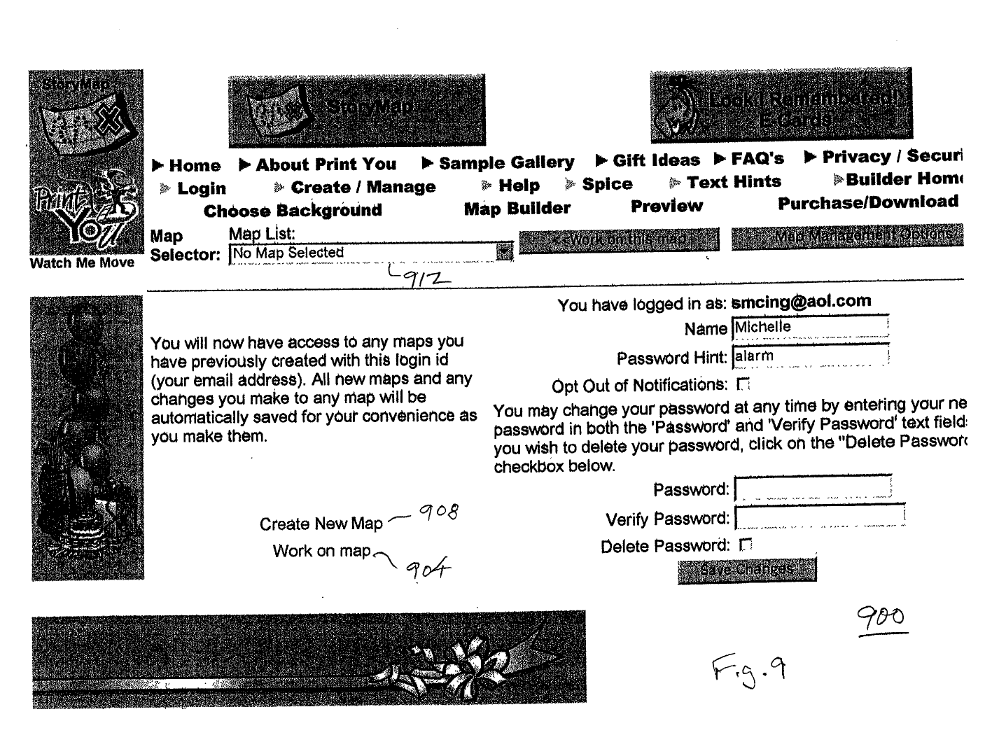

FIG. 8 illustrates a log-in web page 800 presented to a user in response to a selection of the log-in link 704 illustrated in FIG. 7. The log-in web page 800 allows a user to establish a new log-in identity, or to log in using an identity previously established. FIG. 9 illustrates a map selection page 900 presented to a user after the log-in procedure has been completed. Thus, after logging in, the user may access previously created story maps by clicking on the work on map link 904, or may create a new story map by clicking on the new map link 908. In connection with a user desiring to continue work on a story map that has already been started, the name of the story map may be selected in the map selector menu box 912.

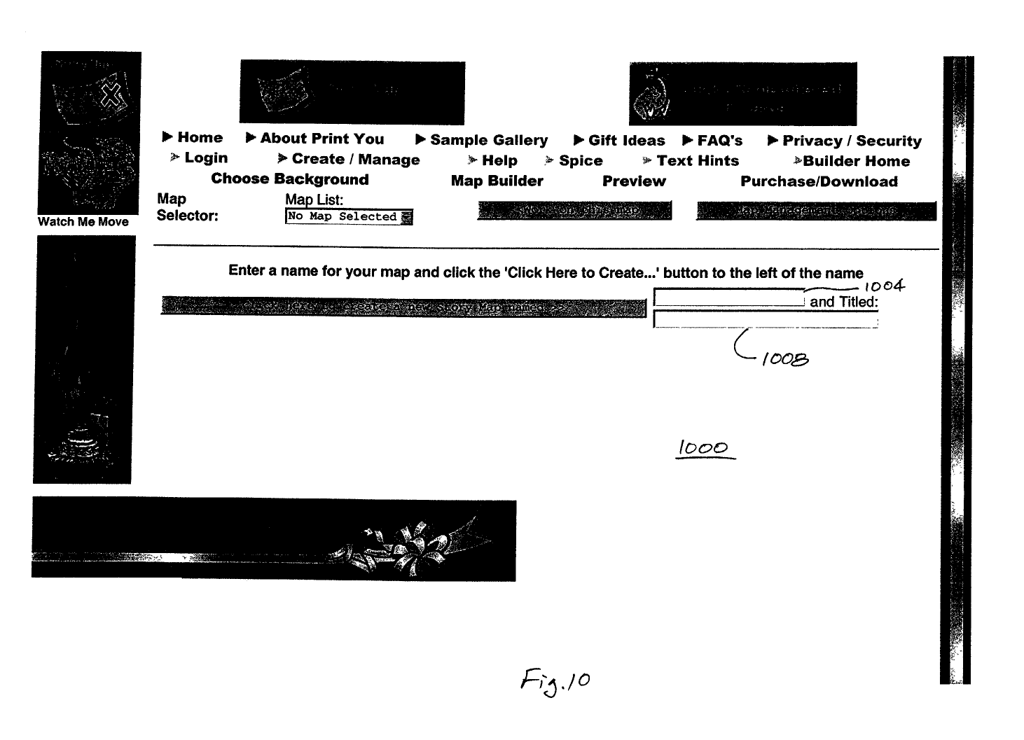

With reference now to FIG. 10, a new map name and title web page 1000 presented to a user creating a new story map is illustrated. A first text box 1004 allows the user to enter a file name for the story map, while a second text box 1008 allows the user to enter a title for the story map. With reference to the sample story map illustrated in FIG. 5, the user, or creator of the sample map 500 might enter “copy sample 1 map” as the file name in the first text box 1004, and “TO A GREAT MARRIAGE!” in the second text box 1008 as the title 532. In addition to being presented after completing the log-in procedure and choosing to create a new story map, the new map name and title page 1000 illustrated in FIG. 10 can be reached by selecting the link to create/manage new maps (second link 708) shown in FIG. 7.

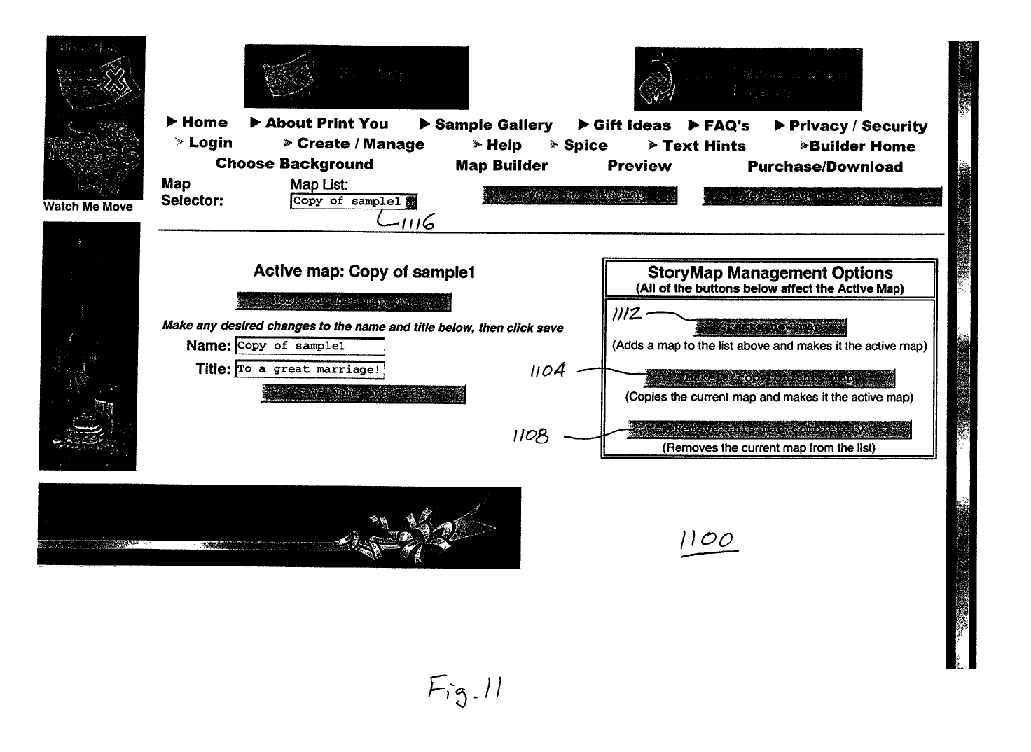

With reference now to FIG. 11, a page 1100 presented to a user in response to a selection to work on a previously created story map (e.g. in response to a selection of link 904 in FIG. 9) is illustrated. The options presented after a user chooses to work on a previously created story map include making a copy of a selected story map 1104, removing the selected story map from the user's list of story maps 1108, and creating a new story map 1112. The story map that is copied in response to a selection of button 1104 or that is removed in response to a selection of button 1108 is selected from the list of story maps associated with the logged-in user presented in the story map selector 1116. It will be noted that making a copy of a story map may be useful where, for example, a user desires to create a new story map that incorporates information or selections associated with a previously created story map.

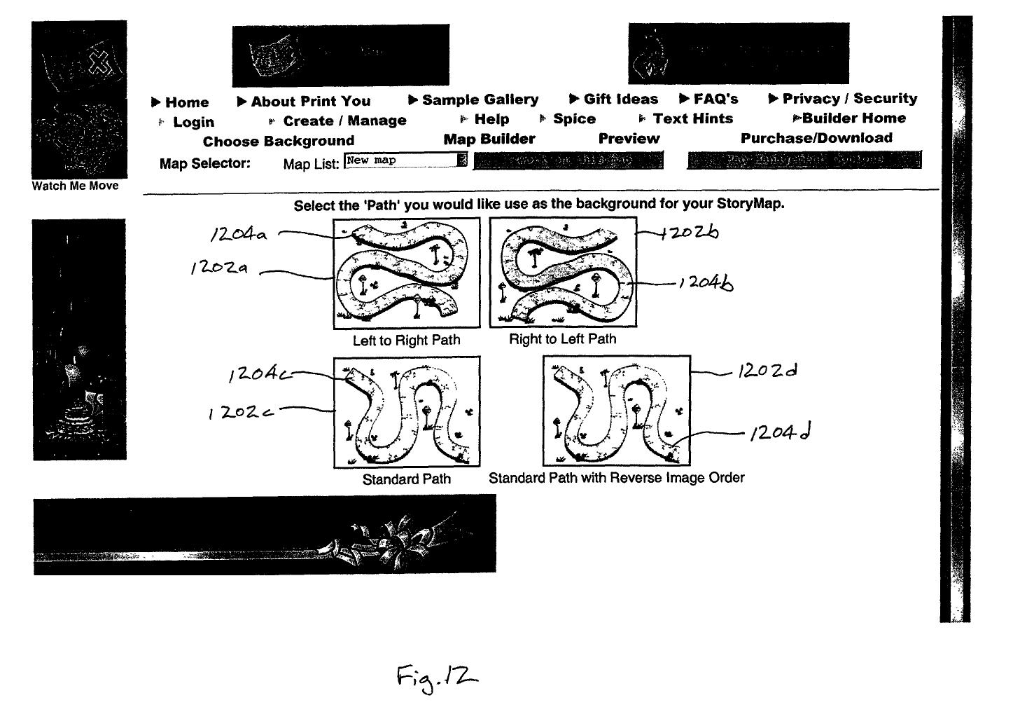

With reference now to FIG. 12, a page 1200 presented to a user allowing the user to select from a number of backgrounds 1202a-d are illustrated. The selection of a background 1202 may be made as a first step in creating a new story map, or after a story map has already been started or completed. In general, the different backgrounds 1202 provide paths 1204 that progress across the page differently. For example, the first background 1202afeatures a path 1204a that progresses from the top left to the bottom right, the second background 1202b has a path 1204b that progresses from the top right to the lower left, the third background 1202c has a path 1204c that progresses from the top left to the bottom right, and the fourth background 1202d has a path 1204d that is identical to that of background 1204c, but the mileposts progress from the lower right to the upper left. In general, although a user may enter text and select images for association with mileposts in any order desired, selecting the standard path with reverse image order 1202d associated with background 1204d after a story map has been completed or started using the third background 1202c will result in a reversal of the order of the text and images along the path 1204. For example, in order to create the story map 500 illustrated in FIG. 5, the user would select the fourth background 1202d having a standard path with reverse image order 1202d by operating a pointing device (e.g. mouse 172) to position a cursor over the fourth background 1202d and clicking a button provided in connection with the pointing device to select that background. According to another embodiment of the present invention, additional or alternate backgrounds 1202 may be provided. Furthermore, according to yet another embodiment of the present invention, the backgrounds 1202 may differ not only in the paths 1204 that are provided, but in the graphical elements presented with the background 1202, the colors associated with the background 1202, the depiction of the path 1204 itself in the number of available mileposts, etc.

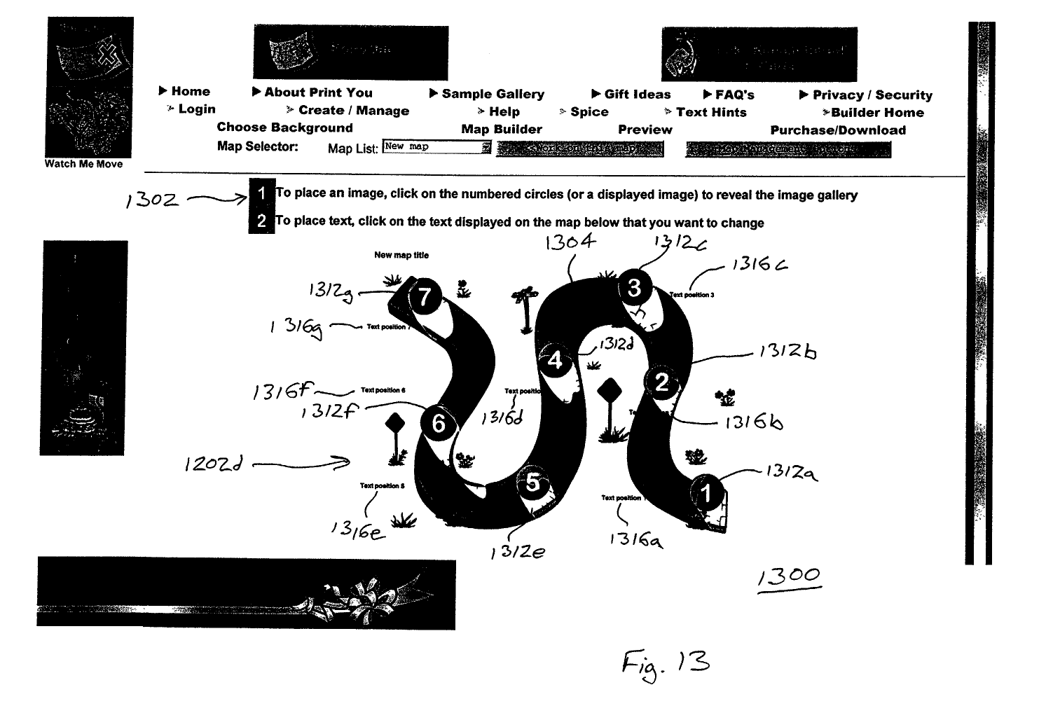

With reference now to FIG. 13, a selected background page 1300 displayed to a user following the selection of the background 1202d having standard path with reverse image order 1204d is illustrated. The selected background page 1300 is the page a user initially is presented with after a background (e.g., background 1202a, b, c or d) has been selected. As shown in FIG. 13, the selected background 1300, here the background 1202d having a standard path with reverse image order 1204d, includes seven image positions 1312a-g and seven text positions 1316a-g. As explained in the instructions 1302 shown in FIG. 13, to place an image along the path 1304, a user must click on any one of the image positions 1312. Similarly, to enter or edit text in any of the text positions 1316, a user is simply required to click on the text position 1316 to be edited.

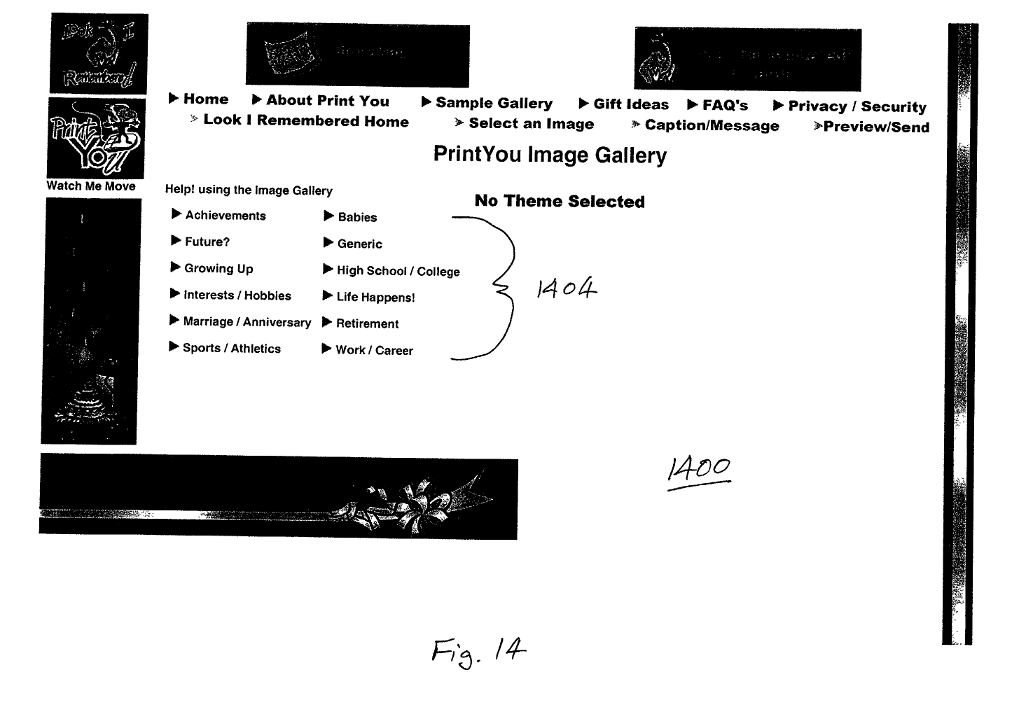

With reference now to FIG. 14, an image theme selection page 1400 displayed to a user in response to a selection of one of the image positions 1312 along the path 1304 is illustrated. In particular, the user is presented with a listing or menu of image themes 1404 used to subdivide the images available for placement on a story map (i.e. in the image positions, for example image positions 1312 along the path 1304). As shown in FIG. 14, the themes 1404 may include achievements; future; growing up; interests/hobbies; marriage/anniversaries; sports/athletics; babies; generic; high school/college; life happens; retirement; and work/career. The division of the complete gallery of images into themes 1404 facilitates the selection of an image by allowing a user to view only those images that are in accordance with a desired theme. In addition, the division of the entire gallery of images into themes 1404 allows the user to be presented with a selection of images that is likely to contain one image suitable for the user's purposes (i.e. in accordance with a desired theme) while removing the need to provide all of the available images to the user at once. Accordingly, the amount of data that must be passed to the user is lessened, increasing the speed with which a story map may be constructed, particularly where the network 108 used to interconnect the server 104 to the client computer 112 interposes significant data transmission delays. Furthermore, the provision of themes 1404 allows the user to efficiently locate a suitable image, even if a very large number of images in total are available for placement on a story map.

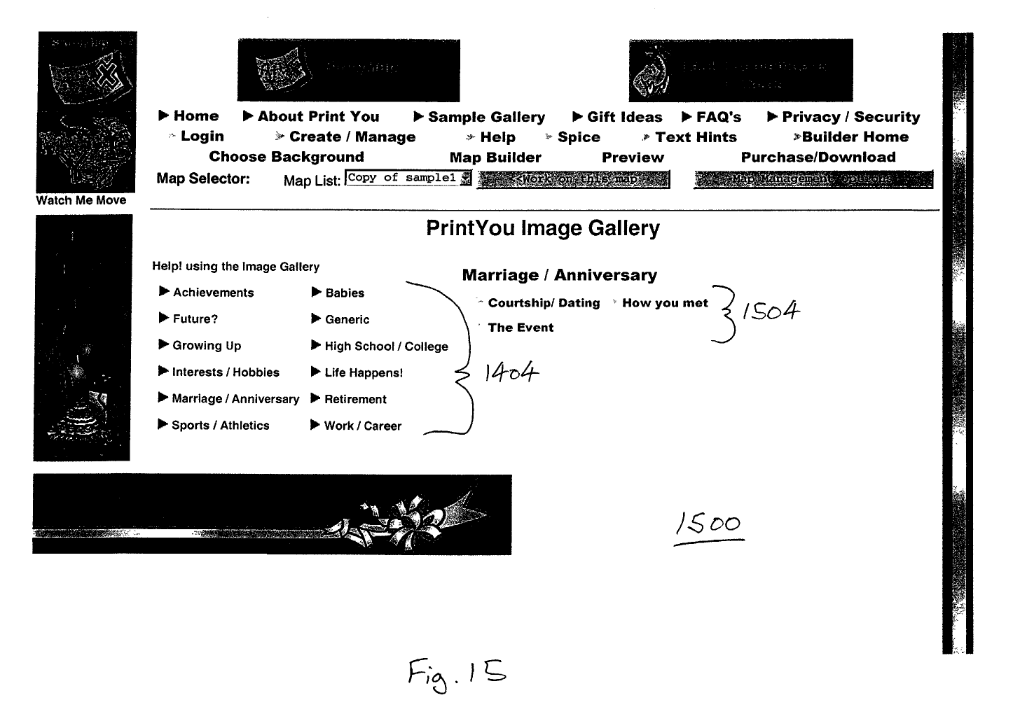

The user may select a theme 1404 using a pointing device (e.g., mouse 172). After a theme 1404 has been selected, the user may be presented with a selection of images related to the selected theme. Alternatively, the user may be presented with a menu or list of sub-themes 1504, such as are illustrated in FIG. 15. In general, FIG. 15 illustrates a subtheme selection page 1500. The subthemes 1504 are used to further divide the available images, and to allow the user to more narrowly define or describe a desired image. After a subtheme 1504, if provided, has been selected, the images included in that subtheme 1504 may be displayed. If no subthemes 1504 are provided, the images are displayed after the selection of a theme 1404. According to an additional embodiment of the present invention, subthemes 1504 may include sub-subthemes.

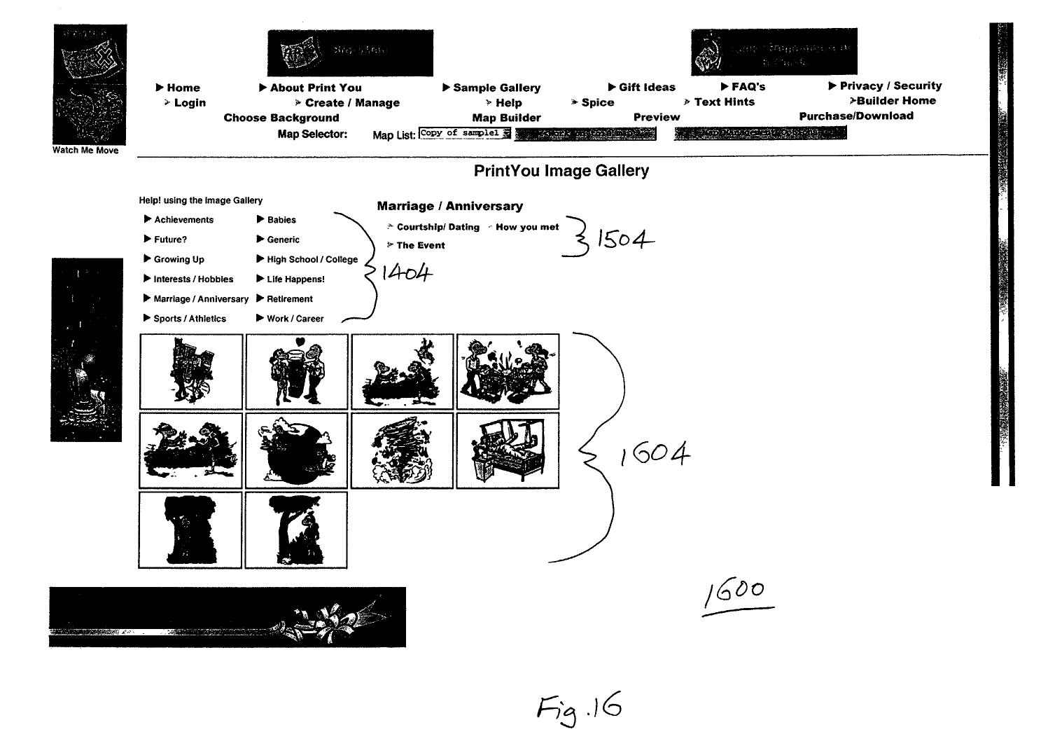

With reference now to FIG. 16, an example of an image selection page 1600 is illustrated. In general, an image selection page is presented after a theme 1404 or subtheme 1504 from which images may be selected is chosen by the user. In general, any one of the images 1604 displayed can be selected by pointing to and clicking on the desired images 1604 (e.g., with mouse 172). The images 1604 need not be exclusively assigned to a single theme 1404 or subtheme 1504. That is, if a single image 1604 can appropriately be classified in a number of themes 1404 and/or subthemes 1504, then that image 1604 may be included in each of those themes 1404 and/or subthemes 1504. For example, an image of a figure holding a trophy might be included among the images in the sports/athletics theme, the achievements theme, and the high school/college theme under the subtheme achievements/honors.

In order to facilitate the sharing of images 1604 among themes 1404 and subthemes 1504, it is convenient to construct pages displaying images in connection with themes 1404 and subthemes 1504 such that those pages refer to images included in the theme 1404 or subtheme 1504 by a file name or address, rather than by incorporating the image data itself for the images in the theme 1404 or subtheme 1504 page. For example, the image selection page 1600 illustrated in FIG. 16 could be constructed by fetching the appropriate images 1508 according to a listing of identifiers associated with those images 1508 when the user selects a subtheme 1504. For example, the images 1604 of FIG. 16 may be presented in response to a selection of the “how you met” subtheme 1504 of the “marriage/anniversary” theme 1404. In this way, pages presenting selections from the image gallery are dynamically generated when presented to a user.

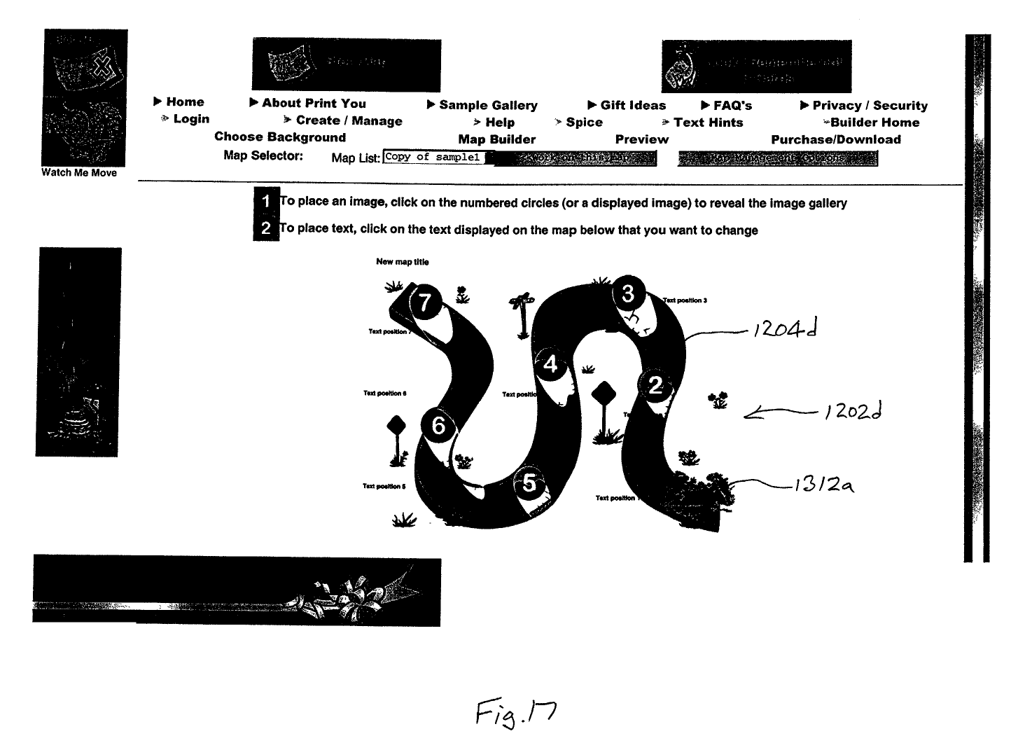

In order to build the example story map 500 shown in FIG. 5, the user would, after selecting the background 1202d as described above, click on the first image position 1312a (see FIG. 13). After being presented with the image theme selection page 1400, the user would select from the marriage/anniversary theme 1404 (see FIG. 14). The subtheme 1504 “courtship/dating” could then be selected from the subtheme selection page 1500, at which point a number of images 1604 in accordance with a theme of courtship and dating are presented as part of the image selection page. The user would then select the desired image, here an image of a blindfolded couple, for example by clicking on that image 1604. The user would then be presented with the selected background 1202d, with the selected image 1604 in the first image position 1312a (see FIG. 17).

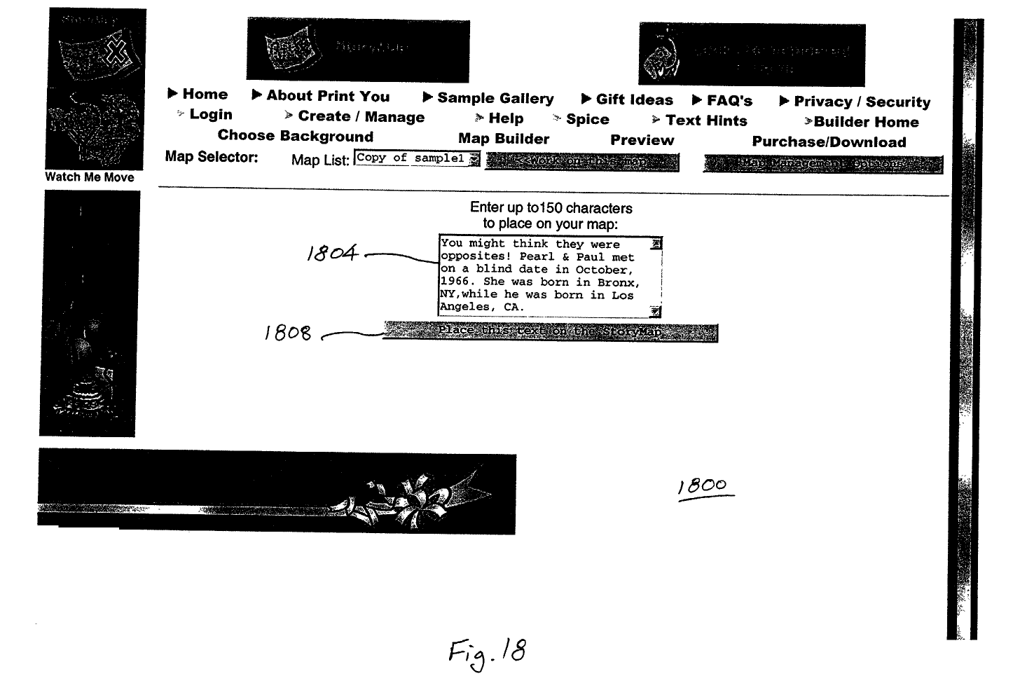

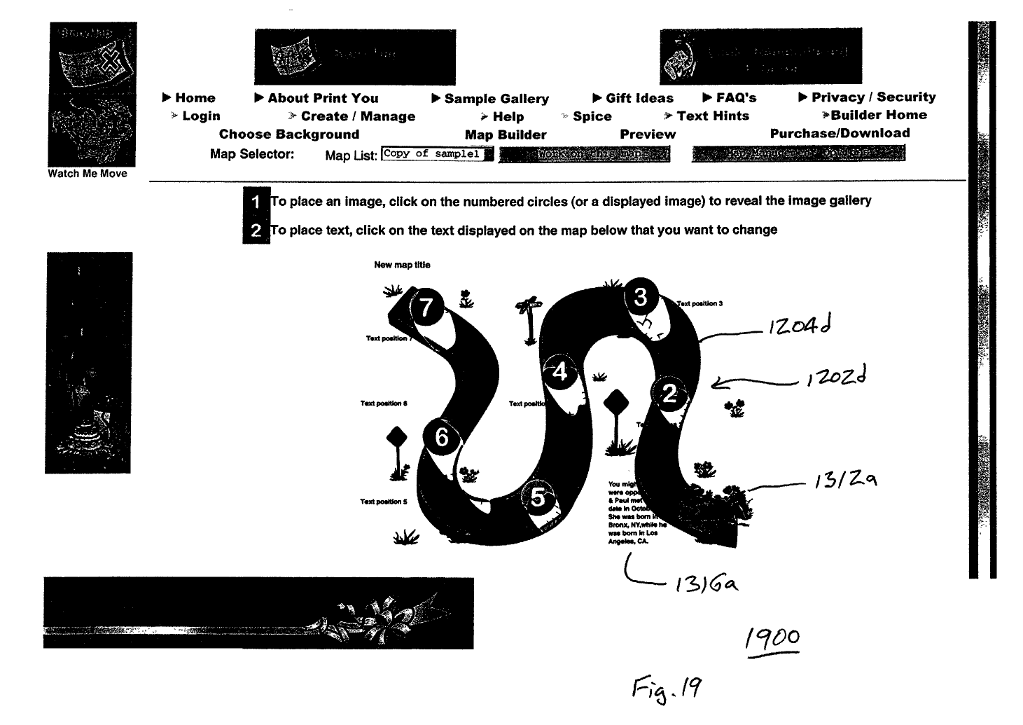

In order to place text on a background, the user selects a text position 1316 (see FIG. 13). For example, the user selects text position 1 1316a using a pointing device. After making the selection of a text position 1316, the user is presented with a text entry page 1800 having a text entry field 1804 (see FIG. 18). The desired text may be entered in the text entry field 1804, for example by typing it in with a keyboard 168 associated with the client computer 112. By pressing the button 1808 labeled “place this text on the story map”, for example using a mouse, the user is presented with a screen showing the entered text in position on the selected background 1202d (see FIG. 19). For example, to enter the text shown at the first text position 516a of the example story map 500 in FIG. 5, the user would select the text position 1 field 1316a alongside the path 1304 (FIG. 13), enter the desired text in the text field 1804 (FIG. 18), and press the “place text” button 1808. The user would then be presented with the selected background 1202d with the entered text in the first text position 1316a (see FIG. 19).

After the user has selected images and entered text, the story map may be previewed. The option to preview the story map may be provided as a menu option or radio button presented to the user. For example, with reference to FIG. 13, the option to preview a story map may be provided as a button 1320 (see FIG. 13). Upon choosing to preview the story map, the user may download a copy of the story map for printing by the client computer 112. In accordance with an embodiment of the present invention, the story map is downloaded as a graphic file. According to a further embodiment of the present invention, the story map for preview is downloaded as a black and white image file having a relatively low resolution. The preview copy is, according to one embodiment of the present invention, provided as a .pdf file. The user may then print the preview copy of the story map as desired.

The user may also choose to purchase the story map that the user has created by selecting the purchase/download button (e.g., button 1324). After selecting the purchase/download button 1324, the user is asked to provide payment information, if such information has not already been collected. Upon payment, the user is provided with the finalized story map as a color image. In addition to being in color, the final version of the story map may be provided at a higher resolution than was utilized in connection with the construction of the story map, or in connection with a preview copy of the story map. The final version of the story map is, in accordance with an embodiment of the present invention, provided as a .pdf file.

In order to facilitate the generation of a high resolution of the selected background and images, the server application 136 may generate a report that includes reference to a high resolution copy of the background 300 and of the selected images. That is, the report used to generate the final version of the story map may make reference to image files containing higher resolution versions of the images used to construct the story map than were provided to the user in connection with the construction of the story map or the generation of a preview copy. According to a further embodiment of the present invention, an even higher resolution version of the story map may be provided for additional cost to users having access to a printer capable of providing a high resolution version and/or a larger page size of the completed story map. After generating the report, the resulting collection of images and, if specified, text, is provided as a single image to the user.

The foregoing discussion of the invention has been presented for purposes of illustration and description. Further, the description is not intended to limit the invention to the form disclosed herein. Consequently, variations and modifications commensurate with the above teachings, within the skill and knowledge of the relevant art, are within the scope of the present invention. The embodiments described hereinabove are further intended to explain the best mode presently known of practicing the invention and to enable others skilled in the art to utilize the invention in such or in other embodiments and with various modifications required by their particular application or use of the invention. It is intended that the appended claims be construed to include the alternative embodiments to the extent permitted by the prior art.

What is claimed is:

1. A method for providing a graphical depiction of events, comprising:
providing a plurality of images to a user for selection;
receiving from said user a selection of a first image;
receiving from said user a selection of a second image; and
displaying said first and second images, wherein said first and second images are juxtaposed along a path to form said graphical depiction of events.

2. The method of claim 1, further comprising:
providing a plurality of paths to said user for selection; and
receiving from said user a selection of one of said paths, wherein said first and second images are juxtaposed along said selected path to form said graphical depiction of events.

3. The method of claim 1, further comprising:
receiving from a user a textual description of a first event with said first image;
associating said first image with said textual description of said first event;
receiving from a user a textual description of a second event;
associating said second image with said textual description of said second event;
displaying said textual description of said first event and said associated first image; and
displaying said textual description of said second event and said associated second image, wherein said textual description of said first event and said associated first image and said textual description of said second event and said associated second image are linearly juxtaposed along a path to form said graphical depiction of events.

4. The method of claim 1, further comprising receiving from said user a selection of a first theme for said graphical depiction of events, wherein said first image is selected from a first set of images, and wherein said first set of images includes images corresponding to said selected theme.

5. The method of claim 4, wherein said first theme is selected from at least one of achievements, future, growing up, interests, hobbies, marriage, anniversary, sports, athletics, babies, generic, high school, college, retirement, work, career, and life change themes.

6. The method of claim 1, further comprising storing said graphical depiction of events as a graphic file.

7. The method of claim 6, further comprising outputting said graphic file to a printer.

8. The method of claim 7, wherein an unlimited number of copies of said graphic file can be outputted to said printer.

9. The method of claim 1, wherein said textual descriptions and associated images of said graphical depiction of events may not be revised by said user after a final version of said graphical depiction of events has been purchased by said user.

10. The method of claim 1, wherein said graphical depiction of events is stored on a server as a file comprising a template, at least a first reference to said first image and at least a second reference to said second image.

11. The method of claim 10, wherein said at least a first reference to said first image and said at least a second reference to said second image comprise universal resource locators.

12. The method of claim 3, further comprising:
receiving from said user a textual description of a third event;
receiving from said user a selection of a third image;
associating said third image with said textual description of said third event, wherein said first event and said associated first image and said second event and said associated second image are positioned along a first branch of said path, wherein said third event is positioned along a second branch of said path, and wherein said first and second branches of said path are parallel to one another.

13. The method of claim 1, wherein said path is displayed as at least one of a road, railroad tracks, a river, a sidewalk and a foot path.

14. A method for providing a graphical depiction of events, comprising:
providing a theme selector input on a display screen;
providing an image selector input on said display screen, wherein images for selection correspond to a selected theme;
providing a text receiving input, wherein text may be provided by a user; and
displaying a selected image and provided text along a path, wherein a plurality of selected images and provided text are positioned along said path.

15. The method of claim 14, further comprising:
providing a path selector input on a display screen, wherein said path may be selected by a user, and wherein said plurality of selected images and provided text are positioned along said selected path.

16. The method of claim 14, wherein said theme is selected from at least one of achievements, future, growing up, interests, hobbies, marriage, anniversary, sports, athletics, babies, generic, high school, college, retirement, work, career, and life change themes.

17. The method of claim 15, wherein said path comprises at least one of a railway, a river, a sidewalk and a foot path.

18. A system for providing a graphical depiction of events, said system comprising:
a) a client computer under control of a user comprising:
i) a processor;
ii) a user display; and
iii) a network interconnection.
b) a communication network interconnected to said network interconnection of said client computer;
c) a server computer, comprising:
i) a processor;
ii) a network interconnection interconnected to said communication network, wherein said server computer is in communication with said client computer;
iii) data storage, wherein data on said data storage comprises:
1) a plurality of background templates; and
2) a plurality of graphical images;
iv) a server executable program, wherein said server executable program is operable to provide said client computer with information for display on said user display comprising:
1) a first menu for selection of a one of said plurality of background templates, wherein said background templates each comprise a path, and wherein at least a one of said background templates provides a plurality of locations at which an image can be positioned;
2) a second menu for selection of a one of a plurality of event themes; and
3) a third menu for selection of a one of a plurality of images associated with said selected one of said plurality of event themes;
wherein a user can construct a graphical depiction of events by selecting a one of said plurality of locations on said at least one background template providing a plurality of locations by making a selection from said second menu of an event theme and by making a selection from said third menu after making said selection from said second menu.

19. The system of claim 18, wherein said client computer further comprises a printer, wherein a hard copy of said graphical depiction of events may be produced by said printer.

20. The system of claim 18, wherein said client computer further comprises a storage device, wherein said graphical depiction of events may be stored as a graphic file.

21. The system of claim 18, wherein said background path comprises at least one of a railway, a river, a sidewalk, and a foot path.

22. A method of providing a story map using a server computer, comprising:
a) providing a server computer, comprising:
i) a processor;
ii) a network interface;
iii) at least a first storage device;
b) interconnecting said server computer to a computer network, wherein said server may be placed in communication with a client computer;
c) storing a plurality of images on said at least a first storage device;
d) storing a plurality of report templates on said at least a first storage device, wherein said plurality of report templates comprise:
i) a plurality of background templates, wherein at least a one of said plurality of background templates comprises a graphical depiction of a path, a plurality of positions at which a selected one of said plurality of images may be placed, and a plurality of positions at which specified text can be placed;
ii) a plurality of themes, wherein a plurality of images are associated with at least a one of said plurality of themes;
e) in response to receiving a selection of a one of said plurality of background templates, providing to said network interface information required to display said selected background template;
f) in response to receiving a selection of a one of said plurality of themes, providing to said network interface information required to display a plurality of images associated with said selected background template; and
g) in response to receiving a selection of a one of said plurality of images, positioning said selected image at a one of said plurality of positions, wherein a story map is created.

23. The method of claim 22, wherein said information required to display said plurality of images associated with said selected background template comprises information required to display said images at a first resolution.

24. The method of claim 23, further comprising providing to said network interface information required to display said story map, wherein said information comprises information required to display said selected image at a second resolution, and wherein said second resolution is greater than said first resolution.

25. The method of claim 24, further comprising, in response to receiving payment for said story map from a user interconnected to said network interface of said server by a computer network, providing information required to display said story map to said network interface, wherein said information comprises information required to display said story map at a third resolution, and wherein said third resolution is greater than said second resolution.

26. The method of claim 22, wherein said server computer does not provide an executable file to said client computer.

27. A server computer apparatus for providing a graphical depiction of events in response to user selections, comprising:
a processor;
a network interface; and
a storage device, wherein a plurality of background templates and a plurality of images are stored, wherein in response to a selection of a one of said plurality of background templates a plurality of image positions are made available for editing, and wherein a selected image may be associated with each of said image positions.

28. The apparatus of claim 27, wherein said first set of graphical images corresponds to a first selected theme.

29. The apparatus of claim 28, wherein said first selected theme is selected from at least one of achievements, future, growing up, interests, hobbies, marriage, anniversary, sports, athletics, babies, generic, high school, college, retirement, work, career, and life change themes.

30. The apparatus of claim 27, wherein a second set of graphical images is received at said network interface and placed in at least one of said memory and said storage, and wherein said second set of images corresponds to a second selected theme.
